(19) United States
(12) Patent Application Publication
(10) Pub. No.: US 2005/0235031 A1
(43) Pub. Date: Oct. 20, 2005

(54) HYPERLINK GENERATION AND ENHANCED SPELL CHECK METHOD, PRODUCT, APPARATUS, AND USER INTERFACE SYSTEM

(76) Inventors: Eric Schneider, University Heights, OH (US); Daniel V Heintz, Cleveland Heights, OH (US)

Correspondence Address: ERIC SCHNEIDER, 13944 CEDAR ROAD, #258, UNIVERSITY HEIGHTS, OH, 44118, US

(21) Appl. No.: 09/658,434

(22) Filed: Sep. 8, 2000

Related U.S. Application Data
(60) Provisional application No. 60/155,367, filed on Sep. 20, 1999.
(60) Provisional application No. 60/153,336, filed on Sep. 10, 1999.

(51) Int. Cl. G06F 15/177; G06F 15/16

(52) U.S. Cl. 709/203; 709/220

(57) ABSTRACT

Abstract of the Disclosure

For each word, a spell check program may determine whether the spelling is correct. If the spelling is correct and an EOF has not been reached, then the next word may be parsed from the current data file. When the spelling is not correct, then it may further be determined whether the word includes a HLD. When it is determined that the word is not a HLD, then a user is prompted to correct the spelling. When it is determined that the word includes a HLD then it may be determined whether the word is to be linked. If the word is to be converted into a link then a hyperlink reference is generated from the word and steps are repeated until an EOF is reached or the next word includes a HLD.

### Detailed Description of the Invention

### Other Applications

This application claims the benefit of the following patent applications, which are hereby incorporated by reference:

1. U.S. Patent Application Ser. No. 09/656,667 filed September 7, 2000, by Schneider, entitled "Method, product, and apparatus for performing an operative function in response to detecting an identifier", which claims the benefit of U.S. Patent Application Ser. No. 09/532,500 filed March 21, 2000, by Schneider, entitled "Fictitious domain name method, product, and apparatus" and claims the benefit of U.S. Provisional Application Ser. No. 60/160,125 filed October 18, 1999, by Schneider, entitled "Method and system for integrating resource location, search services, and registration services", U.S. Provisional Application Ser. No. 60/153,594 filed September 13, 1999, by Schneider entitled "Method and apparatus for using a portion of a URI to select and display advertising", and U.S. Provisional Application Ser. No. 60/153,336 filed September 10, 1999, by Schneider entitled "Method and apparatus for generating hyperlink references and/or performing an operative function in response to detected indicia."

2. U.S. Patent Application Ser. No. 09/532,500 filed March 21, 2000, by Schneider, entitled "Fictitious domain name method, product, and apparatus", which claims the benefit of U.S. Patent Application Ser. No. 09/525,350 filed March 15, 2000, by Schneider, entitled "Method for integrating domain name registration with domain name resolution" and claims the benefit of U.S. Provisional Application Ser. No. 60/143,859 filed July 15, 1999, by Schneider entitled "Method and apparatus for generation, registration, resolution, and emulation of name space", now abandoned, U.S. Provisional Application Ser. No. 60/135,751 filed May 25, 1999, by Schneider entitled "Method and system for name space resolution", now abandoned and U.S. Provisional Application Ser. No. 60/125,531 filed March 22, 1999, by Schneider entitled "Method and system for the emulation of name space", now abandoned.

3. U.S. Provisional Application Ser. No. 60/155,367 filed September 20, 1999, by Schneider, et al., entitled "Method and apparatus for generating hyperlink references from spell checking."

4. U.S. Provisional Application Ser. No. 60/153,336 filed September 10, 1999, by Schneider entitled "Method and apparatus for generating hyperlink references and/or performing an operative function in response to detected indicia."

### Field of the Invention

This invention generally relates to hyperlink references, and more specifically relates to a method, product, and apparatus for generating hyperlink references from using a spell check program.

### Background of the Invention

The Internet is a vast computer network consisting of many smaller networks that span the entire world. A network provides a distributed communicating system of computers that are interconnected by various electronic communication links and computer software protocols. Because of the Internet's distributed and open network architecture, it is possible to transfer data from one computer to any other computer worldwide. In 1991, the World-Wide-Web (WWW or Web) revolutionized the way information is managed and distributed.

The Web is based on the concept of hypertext and a transfer method known as Hypertext Transfer Protocol (HTTP) which is designed to run primarily over a Transmission Control Protocol/Internet Protocol (TCP/IP) connection that employs a standard Internet setup. A server computer may issue the data and a client computer displays or processes it. TCP may then convert messages into streams of packets at the source, then reassemble them back into messages at the destination. Internet Protocol (IP) handles addressing, seeing to it that packets are routed across multiple nodes and even across multiple networks with multiple standards. HTTP protocol permits client systems connected to the Internet to access independent and geographically scattered server systems also connected to the Internet.

Client side browsers, such as Netscape Navigator and/or Microsoft Internet Explorer (MSIE) provide graphical user interface (GUI) based client applications that implement the client side portion of the HTTP protocol. One format for information transfer is to create documents using Hypertext Markup Language (HTML). HTML pages are made up of standard text as well as formatting codes that indicate how the page should be displayed. The client side browser reads these codes in order to display the page. A web page may be static and requires no variables to display information or link to other predetermined web pages. A web page is dynamic when arguments are passed which are either hidden in the web page or entered from a client browser to supply the necessary inputs displayed on the web page. Common Gateway Interface (CGI) is a standard for running external programs from a web server. CGI specifies how to pass arguments to the executing program as part of the HTTP server request. Commonly, a CGI script may take the name and value arguments from an input form of a first web page which is be used as a query to access a database server and generate an HTML web page with customized data results as output that is passed back to the client browser for display.

The Web is a means of accessing information on the Internet that allows a user to "surf the web" and navigate Internet resources intuitively, without technical knowledge. The Web dispenses with command-line utilities, which typically require a user to transmit sets of commands to communicate with an Internet server. Instead, the Web is made up of millions of interconnected web pages, or documents, which may be displayed on a computer monitor. Hosts running special servers provide the Web pages. Software that runs these Web servers is relatively simple and is available on a wide range of computer platforms including PC's. Equally available is a form of client software, known as a Web browser, which is used to display Web pages as well as traditional non-Web files on the client system.

A network resource identifier such as a Uniform Resource Identifier (URI) is a compact string of characters for identifying an abstract or physical resource. URIs are the generic set of all names and addresses that refer to objects on the Internet. URIs that refer to objects accessed with existing protocols are known as Uniform Resource Locators (URLs). A URL is the address of a file accessible on the Internet. The URL contains the name of the protocol required to access the resource, a domain name, or IP address that identifies a specific computer on the Internet, and a hierarchical description of a file location on the computer. For example the URL "http://www.example.com/index.html", where "http" is the scheme or protocol, "www.example.com" is the Fully Qualified Domain Name (FQDN), and "index.html" is the filename located on the server.

A domain name consists of two parts: a host and a domain. Technically, the letters to the right of the "dot" (e.g., tut.net) are referred to as Top Level Domains (TLDs), while hosts, computers with assigned IP addresses that are listed in specific TLD registries are known as second-level domains (SLDs). For the domain name "tut.net", ".net" is the TLD, and "tut" is the SLD. Domain name space is the ordered hierarchical set of all possible domain names either in use or to be used for locating an IP address on the Internet. TLDs are known as top-level domains because they comprise the highest-order name space available on the Internet. Second-level domains, as well as third-level domains (3LDs) such as "king.tut.net", are subsidiary to TLDs in the hierarchy of the Internet's DNS.

URLs are used in media and written in documents or typed within e-mail, and data files, etc. as a means to make reference to accessible online content that helps express the context of the ideas one wishes to communicate. URLs are generally written in an abbreviated manner as partial URLs or domain names (e.g., "http://www.example.com" is the URL, "www.example.com" is the FQDN, and "example.com" is the domain name). During the early stages of commercialization on the Internet, businesses displayed the full URL when advertising a commercial or display ad as a means to locate the resources of the business on the Internet. Improvements have been made to recognize partial URLs when entered in the location field of a web browser or network accessible device for automatically appending protocol information so a full URL request can be made. By submitting a domain name or FQDN in the location field, the browser modifies the request by adjusting the partial URL and adding "http://" in front of the domain name or FQDN in order to construct a valid URL. As a result of this convenience, companies have modified their advertising and distribution of URLs through print, film, radio, television and other media as "example.com" or "www.example.com" instead of the URL "http://www.example.com". Though a helpful mnemonic for consumers to more readily identify and access the location and origin of goods and services on a public network such as the Internet, the mnemonic is only applicable when using a command line of a device or location field of a web browser program as a means to access the advertised web site.

The convenience of entering a URL in an abbreviated manner in the location field has also affected how references to URLs are communicated through other media. For example, it is common place to include partial URLs such as a domain name or FQDN as an abbreviation to a URL particularly within data files, text files, and e-mail. Though the adaptation of communicating URLs has been abbreviated for the sake of time, memory, and repetition, there exists no method or device that successfully integrates the abbreviated use of URLs in other applications.

Text editors (e.g., word processing application) provide the ability to manipulate text. Many text editors provide some proofreading capability. In most text editors, this capability includes a spelling checker for identifying spelling errors. Other examples include tools for detecting grammatical and punctuation errors. Proofreading processing includes error detection, communication, and correction.

For example, a spelling checker scans text to identify errors and provide ability to correct errors. A spelling checker compares each word of the document with a spelling dictionary. Spelling errors are detected when a word in the text is not in the spelling dictionary. If the word is not located in the dictionary, the word is considered to be spelled incorrectly (an "error"). The error is communicated to the user, and the user indicates how the error is to be corrected.

Existing limitations are evident particularly when using Microsoft (MS) products for spell checking in word processing and e-mail composition applications. When a URL or FQDN is typed into such applications, the program automatically creates a hyperlink reference by using the URL or FQDN as the label portion of the hyperlink reference. For instance, entering the FQDN "www.example.com", would immediately be displayed with an underline denoting that the program automatically recognized the FQDN as a hyperlink by tagging FQDN in real-time to form the hyperlink reference in HTML language:

<A HREF="http://www.example.com">www.example.com</A>

The automatic generation of a hyperlink particularly with respect to a FQDN indicates the acknowledgement that hyperlinks are becoming prevalent as a part of everyday language. In previous software versions, a FQDN was treated as a spelling error.

The use of the "." delimiter in most languages denotes the end of a sentence whereas the use of the "." delimiter in the DNS system denotes the hierarchy of domain levels within a domain name. The minimum requirements for indicating a valid URL is by including a domain name or IP address to locate a particular server on the Internet. The "." functions as a delimiter that exists in two separate namespaces (the namespace of language and the namespace of the DNS) that are converging due to the commercial impact of the Internet.

Though the above applications support the automatic hyperlinking of a URL or FQDN, there is no extended support to provide further diagnostic by testing the validity of the generated URI or FQDN. This can be demonstrated by typing in "http://www.example.company", "www.example.company", "http://e", "www.e", "ftp://e", "ftp.e". In each case, the application automatically generates a hyperlink without verifying that ".company" is not a resolvable TLD nor that a TLD is even present indicating that hyperlink generation is based on a small table of keywords to denote protocol or host server name such as "http", "ftp", "telnet", "www", etc. Furthermore, when a domain name such as "example.com" or "example.company" is entered there is no support whatsoever for automatically hyperlinking the domain name and in some cases is processed as a spelling error further supporting that TLD detection in spell checking is not a consideration.

U.S. patent 5,907,680 issued on May 25, 1999, by Nielsen, which is entitled, "Client-side, server-side and collaborative spell check of URLs" is a system that applies spell check as a navigational tool used in conjunction with the location field of a web browser. U.S. patent 5,892,919 issued on April 6, 1999, by Nielsen, which is entitled, "Spell checking universal resource locator (URL) by comparing the URL against a cache containing entries relating incorrect URLs submitted by users to corresponding correct URLs" is a similar system as discussed above. Though both Nielsen patents teach the importance of applying spell checking methodologies to URLs, the patents apply strictly to URLs and resource navigation only and does not contemplate broader applications of URLs in contexts other than resource navigation or applied to other fields such as the area of word processing for example.

In a hierarchical naming system such as the DNS, a first domain represents the highest level domain (HLD). A HLD that is determined not resolvable is referred to as a Top Level Domain Alias (TLDA). A resolvable HLD is referred to as a Top Level Domain (TLD). Specific methods for applying TLDAs and hyperlink generation are explained in U.S. Patent Application Ser. No. 09/532,500 filed March 21, 2000, by Schneider, entitled "Fictitious domain name method, product, and apparatus" and U.S. Provisional Application Ser. No. 60/153,336 filed September 10, 1999, by Schneider entitled "Method and apparatus for generating hyperlink references and/or performing an operative function in response to detected indicia."

As demonstrated there exists a need to overcome the limitations of the prior art by providing more effective solutions for the automatic generation of hyperlinks so that partial URLs can be used on all platforms and in all applications aside from the current abbreviated use through the location field of a web browser or in its very limited use in spell check word processing applications. Accordingly, in light of the above, there is a strong need in the art for a method, product, and apparatus for generating hyperlink references from using a spell check program.

### Summary of the Invention

Briefly, this invention relates to a method and system for generating hyperlink references by using a spell check program. The present invention provides a way to more effectively manage URI namespace within written or spoken language. The invention enables a user to convert a misspelled word into a hyperlink reference. The present invention enables the user to access added GUI interface functions for any spell check program. The invention allows for on-the-fly spell checking as input is received one symbol or character at a time while greatly improving the functions of generating hyperlinks from misspelled words by testing for validity and/or resolvability. The present invention allows for TLDA methodologies as discussed in other co-pending provisional applications to be applied with respect to spell checking. The invention enables the ubiquitous extended use of spell checking to be applied to real time text such as but not limited to teletext, closed caption, text converted from audio signals, instant messaging, web conferencing, etc.

In general, in accordance with the present invention a method for processing text includes the steps of parsing a word from the text, determining that the word includes a highest-level domain (HLD), and distinguishing the word from any other word that does not include the HLD. The word may be created by extracting all symbols between any two consecutive " " delimiters from the text. The word may includes a "." delimiter followed by any symbol other than that of a " " delimiter before determining that the word includes the HLD. The word may be compared to a table of resolvable top level domains (TLDs). A font, character size, color, underline, redline, background attribute, and/or reverse video may be selected to provide a distinguishing characteristic to distinguish one word from another.

The text may also be processed with a spell checker by determining from the spell checker that the text includes a spelling error, determining that the spelling error includes the HLD, and generating a hyperlink corresponding to the spelling error. The spelling error may be compared to a table of resolvable TLDs. The hyperlink may be used to replace the spelling error. A user interface element may be used to select from one of a label, resolution method, and hyperlink activation to assist in hyperlink generation.

In yet another aspect of the present invention, a GUI interface is provided for converting a spelling error into a hyperlink reference. Additional interface characteristics may be used in addition to the conventional interface for spell checkers of the prior art by including features such as a button object for linking a spelling error, a list box object for selecting what label and link method may be used to generate a hyperlink reference from the misspelled word, and a text box object for providing a label name that may be used in conjunction with the selection from the list box object for generating a hyperlink reference when the button object for linking is activated from received input. Furthermore, the list box and text box object may be hidden from view until the button object for linking is activated.

In accordance with yet additional aspects of the present invention, an apparatus which implements substantially the same functionality in substantially the same manner as the methods described above is provided.

In accordance with other additional aspects of the present invention, a computer-readable medium that includes computer-executable instructions may be used to perform substantially the same methods as those described above is provided.

The foregoing and other features of the invention are hereinafter fully described and particularly pointed out in the claims. The following description and the annexed drawings set forth in detail one or more illustrative aspects of the invention, such being indicative, however, of but one or a few of the various ways in which the principles of the invention may be employed.

### Brief Description of the Drawings

Fig. 1a is a block diagram of an exemplary distributed computer system in accordance with the present invention.

Fig. 1b is a diagram depicting the location field or web page search request used in a conventional web browser.

Fig. 1c is a block diagram illustrating exemplary information records stored in memory in accordance with the present invention.

Fig. 2 is a flowchart illustrating the steps performed for generating hyperlinks based on detecting a highest level domain (HLD) in accordance with the present invention.

Fig. 3 is a flowchart illustrating the steps performed by a prior art system for executing a spell check program.

Fig. 4a is a flowchart illustrating the steps performed for detecting a HLD with a spell check program to more effectively manage URI namespace within written language in accordance with the present invention.

Fig. 4b is an illustration depicting a GUI interface for converting a spelling error into a hyperlink reference in accordance with the present invention.

Fig. 4c presents an exemplary table in accordance with the present invention illustrating a data structure for storing the received input from the GUI.

Fig. 5 is a flowchart illustrating the steps performed for spell checking as characters or symbols are entered, processed, or received one symbol or one character at a time in accordance with the present invention.

### Detailed Description of the Invention

The present invention will now be described with reference to the drawings, wherein like reference numerals are used to refer to like elements throughout.

Turning first to the nomenclature of the specification, the detailed description that follows represents processes and symbolic representations of operations by conventional computer components, including a local processing unit, memory storage devices for the local processing unit, display devices, and input devices. Furthermore, these processes and operations may utilize conventional computer components in a heterogeneous distributed computing environment, including remote file servers, computer servers, and memory storage devices. These distributed computing components may be accessible to the local processing unit by a communication network.

The processes and operations performed by the computer include the manipulation of data bits by a local processing unit and/or remote server and the maintenance of these bits within data structures resident in one or more of the local or remote memory storage devices. These data structures impose a physical organization upon the collection of data bits stored within a memory storage device and represent electromagnetic spectrum elements.

A process may generally be defined as being a sequence of computer-executed steps leading to a desired result. These steps generally require physical manipulations of physical quantities. Usually, though not necessarily, these quantities may take the form of electrical, magnetic, or optical signals capable of being stored, transferred, combined, compared, or otherwise manipulated. It is conventional for those skilled in the art to refer to these signals as bits or bytes (when they have binary logic levels), pixel values, works, values, elements, symbols, characters, terms, numbers, points, records, objects, images, files, directories, subdirectories, or the like. It should be kept in mind, however, that these and similar terms should be associated with appropriate physical quantities for computer operations, and that these terms are merely conventional labels applied to physical quantities that exist within and during operation of the computer.

It should also be understood that manipulations within the computer are often referred to in terms such as adding, comparing, moving, positioning, placing, illuminating, removing, altering, etc., which are often associated with manual operations performed by a human operator. The operations described herein are machine operations performed in conjunction with various input provided by a human operator or user that interacts with the computer. The machines used for performing the operation of the present invention include local or remote general-purpose digital computers or other similar computing devices.

In addition, it should be understood that the programs, processes, methods, etc. described herein are not related or limited to any particular computer or apparatus nor are they related or limited to any particular communication network architecture. Rather, various types of general-purpose machines may be used with program modules constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory, such as read only memory.

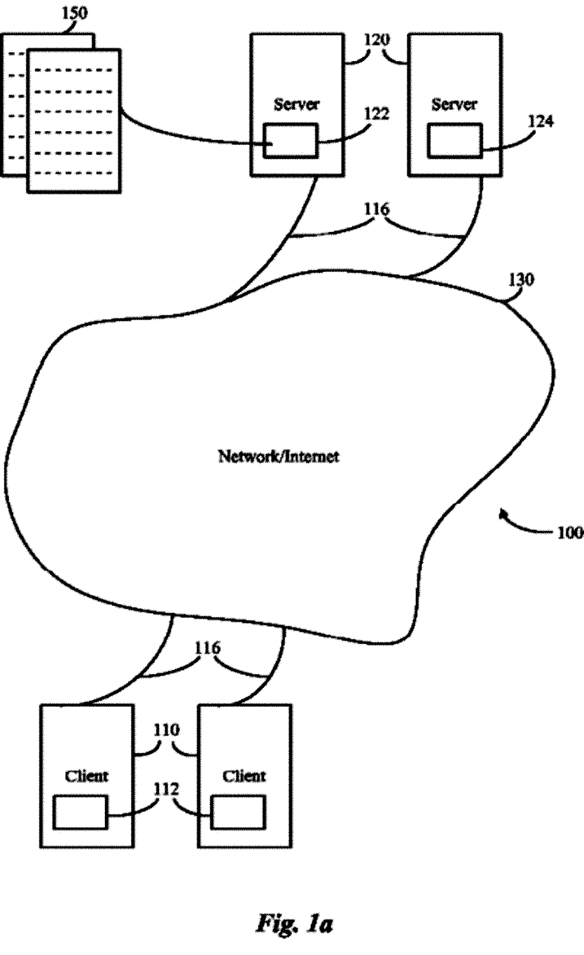

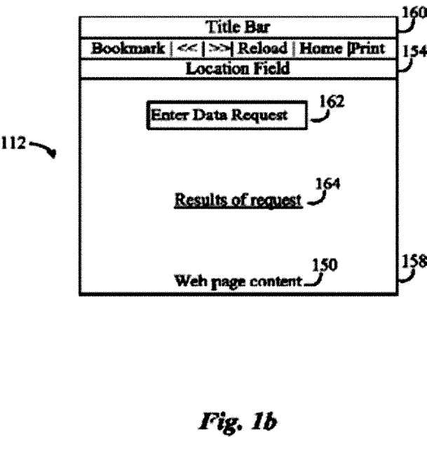

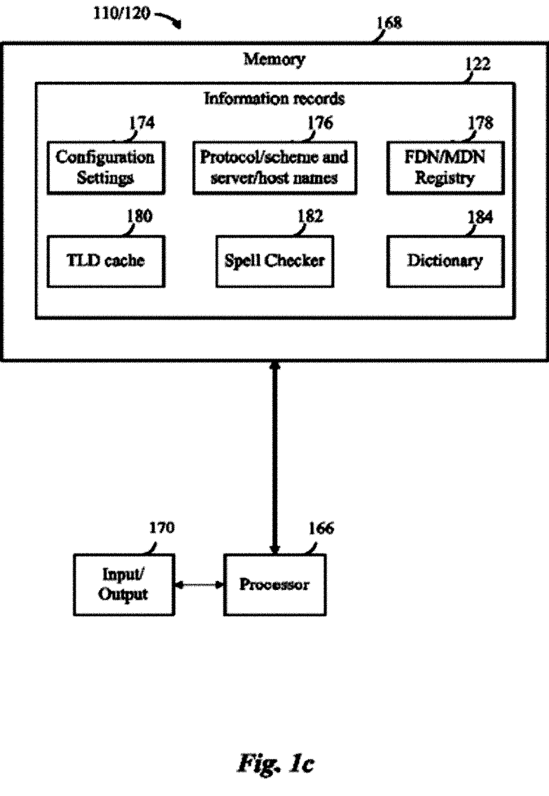

Fig. 1a illustrates an exemplary system for providing a distributed computer system 100 in accordance with one aspect of the present invention and includes client computers or any network access apparatus 110 connected to server computers 120 via a network 130. The network 130 may use Internet communications protocols (IP) to allow clients 110 to communicate with servers 120. The communication device of a network access apparatus 110 may include a transceiver, a modem, a network interface card, or other interface devices to communicate with the electronic network 130. The network access apparatus 110 may be operatively coupled to and/or include a Global Positioning System (GPS). The modem may communicate with the electronic network 130 via a line 116 such as a telephone line, an ISDN line, a coaxial line, a cable television line, a fiber optic line, or a computer network line. Alternatively, the modem may wirelessly communicate with the electronic network 130. The electronic network 130 may provide an on-line service, an Internet service provider, a local area network service, a wide area network service, a cable television service, a wireless data service, an intranet, a satellite service, or the like.

The client computers 110 may be any network access apparatus including hand held devices, palmtop computers, personal digital assistants (PDAs), notebook, laptop, portable computers, desktop PCs, workstations, and/or larger/smaller computer systems. It is noted that the network access apparatus 110 may have a variety of forms, including but not limited to, a general purpose computer, a network computer, a network television, an internet television, a set top box, a web-enabled telephone, an internet appliance, a portable wireless device, a television receiver, a game player, a video recorder, and/or an audio component, for example.

Each client 110 typically includes one or more processors, memories, and input/output devices. An input device may be any suitable device for the user to give input to client computer 110, for example: a keyboard, a 10-key pad, a telephone key pad, a light pen or any pen pointing device, a touchscreen, a button, a dial, a joystick, a steering wheel, a foot pedal, a mouse, a trackball, an optical or magnetic recognition unit such as a bar code or magnetic swipe reader, a voice or speech recognition unit, a remote control attached via cable or wireless link to a game set, television, and/or cable box. A data glove, an eye tracking device, or any MIDI device may also be used. A display device may be any suitable output device, such as a display screen, text-to-speech converter, printer, plotter, fax, television set, or audio player. Although the input device is typically separate from the display device, they could be combined; for example: a display with an integrated touchscreen, a display with an integrated keyboard, or a speech-recognition unit combined with a text-to-speech converter.

The servers 120 may be similarly configured. However, in many instances server sites 120 include many computers, perhaps connected by a separate private network. In fact, the network 130 may include hundreds of thousands of individual networks of computers. Although the client computers 110 are shown separate from the server computers 120, it should be understood that a single computer may perform the client and server roles. Those skilled in the art will appreciate that the computer environment 100 shown in Fig. 1a is intended to be merely illustrative. The present invention may also be practiced in other computing environments. For example, the present invention may be practiced in multiple processor environments wherein the client computer includes multiple processors. Moreover, the client computer need not include all of the input/output devices as discussed above and may also include additional input/output devices. Those skilled in the art will appreciate that the present invention may also be practiced via Intranets and more generally in distributed environments in which a client computer requests resources from a server computer.

During operation of the distributed system 100, users of the clients 110 may desire to access information records 122 stored by the servers 120 while utilizing, for example, the Web. Furthermore, such server systems 120 may also include one or more search engines having one or more databases 124. The records of information 122 may be in the form of Web pages 150. The pages 150 may be data records including as content plain textual information, or more complex digitally encoded multimedia content, such as software programs, graphics, audio signals, videos, and so forth. It should be understood that although this description focuses on locating information on the World-Wide-Web, the system may also be used for locating information via other wide or local area networks (WANs and LANs), or information stored in a single computer using other communications protocols.

The clients 110 may execute Web browser programs 112, such as Netscape Navigator or MSIE to locate the pages or records 150. The browser programs 112 enable users to enter addresses of specific Web pages 150 to be retrieved. Typically, the address of a Web page is specified as a URI or more specifically as a URL. In addition, when a page has been retrieved, the browser programs 112 may provide access to other pages or records by "clicking" on hyperlinks (or links) to previously retrieved Web pages. Such links may provide an automated way to enter the URL of another page, and to retrieve that page.

Fig. 1b more specifically illustrates an exemplary selection of common operative components of a web browser program 112. The web browser 112 enables a user to access a particular web page 150 by typing the URL for the web page 150 in the location field 154. The web page 150 contents corresponding to the URI from the location field 154 may be displayed within the client area of the web browser display window 158, for example. Title information from the web page 150 may be displayed in the title bar 160 of the web browser 112. The web page 150 contents may further include a user interface element such as that of an input text box 162 for inputting data requests and, in turn, the results of such data requests 164. Results may usually be provided as hyperlinks.

Fig. 1c illustrates a block diagram of a storage device such as memory 168 in operative association with a processor 166. The processor 166 is operatively coupled to input/output devices 170 in a client 110 and/or server 120 computing system. Stored in memory 168 may be information records 122 having any combination of exemplary content such as scripts, lists, files, and databases. Such records may include for example: user modifiable configuration settings 174, protocol/server names 176, FDN/MDN Registry 178, TLDs 180, spell checker 182, and dictionary 184. These records may be further introduced and discussed in more detail throughout the disclosure of the present invention.

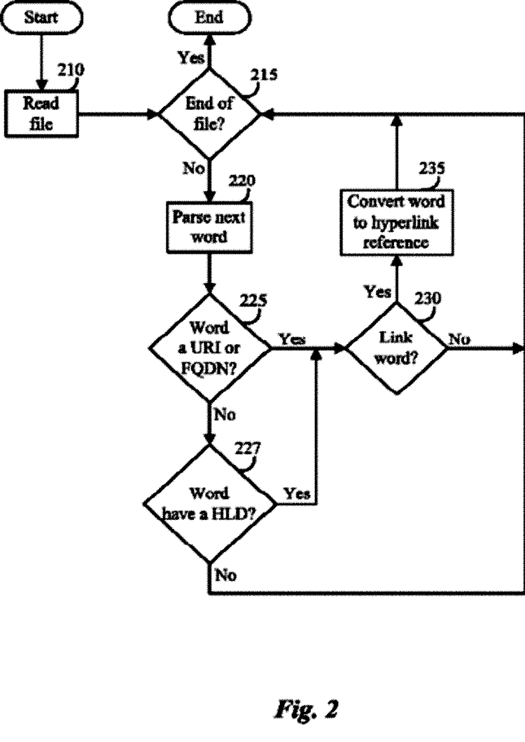

As explained in U.S. Provisional Application Ser. No. 60/153,336 filed September 10, 1999, by Schneider entitled "Method and apparatus for generating hyperlink references and/or performing an operative function in response to detected indicia", Fig. 2 is a flowchart illustrating the steps performed for generating hyperlinks based on detecting a highest level domain (HLD). A device such as a network access apparatus 110, servlet, applet, stand-alone executable program, a command line, or user interface element such as a text box object or location field 154 of a web browser 112, receives and parses input such as text or voice in step 210. An input file may be read from memory 168 and it may be determined in step 215 whether an end of file (EOF) marker is read. Upon EOF, the script or program completes execution. While an EOF has not been reached, steps may be performed to parse words in step 220 from the input file 210. For each word it may be determined (step 225) whether the word is a URI or FQDN or whether the word at the very least includes a HLD (step 227). Unfortunately, the only methods practiced by one of ordinary skill in the art with respect to detecting a URI and/or FQDN in word processing applications rely on detecting only a prefix such as the protocol/scheme "http://" or a subdomain/host name called "www".

To process a HLD (step 227), the word may be compared to a list of resolvable TLDs or TLD cache 180 to determine HLD resolvability. When the HLD is determined to be not resolvable, then the HLD is a TLDA, and it may be further determined whether the word includes any multilingual domain names (MDNs) by consulting a FDN/MDN registry 178. If so, then input may be processed as a MDN. Whenever a TLDA is detected, the domain name is determined fictitious and the step of consulting a MDN/FDN registry 178 or spell checker 182, may be employed to assist with identifier generation/selection and data request processing in general.

When it is determined in step 225 that the word is not a URI or FQDN, it may further be determined in step 227 whether the word includes a HLD. When it is determined that the word is not a HLD, then steps may be repeated (215, 220, 225) until an EOF is reached or the word is either a URI or FQDN, or includes a HLD. When it is determined (225, 227) that either the word is a URI or FQDN or that the word includes a HLD then it may be determined in step 230 whether the word is to be converted. If the word is not to be converted then steps may be repeated (215, 220, 225) until an EOF is reached or the word is a URI or FQDN. If the word is to be converted, then a hyperlink reference may be generated from the word and then steps may be repeated (215, 220, 225) until an EOF is reached or the word is either a URI or FQDN or includes a HLD.

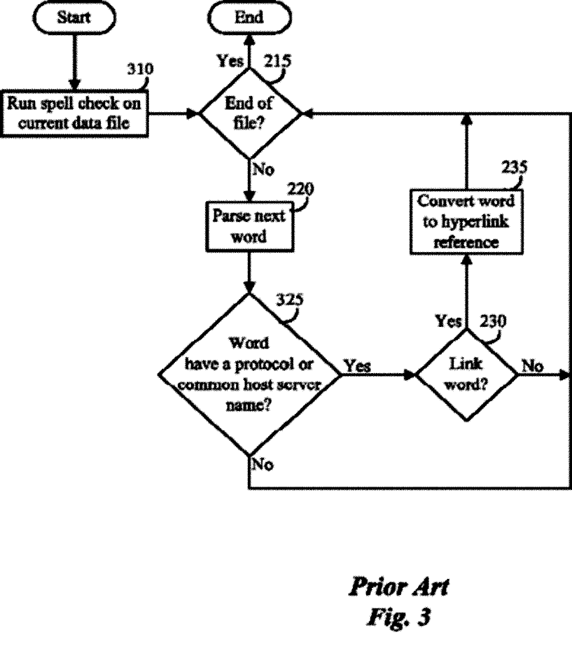

Fig. 3 illustrates a prior art system for executing a spell check program as discussed in the background of the invention. The steps for "spell checking" are not included to emphasize how a spell check program processes a URI or FQDN. A device, network access apparatus 110, or web browser 112 executes a spell check program from memory (e.g., RAM) 168, either automatically or in response to an input device where a current data file may be read in step 310 from memory 168 and then determined in step 215 whether an end of file (EOF) marker is read. Upon EOF, the script or program completes execution. While an EOF has not been reached, steps may be performed to parse in step 220 words from the current data file 310. For each word, it may be determined in step 325 whether the word includes a protocol or common host server name such as "http", "ftp", "telnet", "www", etc. by consulting a table of protocol/server names 176. When it is determined that the word does not match a keyword, such as protocol or common host server name, then steps may be repeated (215, 220, 325) until an EOF is reached or a keyword is matched. When it is determined that a keyword is matched, then it may be determined in step 230 whether the word is to be converted into a hyperlink reference. This decision block may be configured to unconditionally convert the detected word. If the word is not converted, then steps are repeated (215, 220, 325) until an EOF is reached or a keyword is matched. If the word is to be converted, then a hyperlink reference may be generated from the word and then steps may be repeated (215, 220, 325) until an EOF is reached or a keyword is matched.

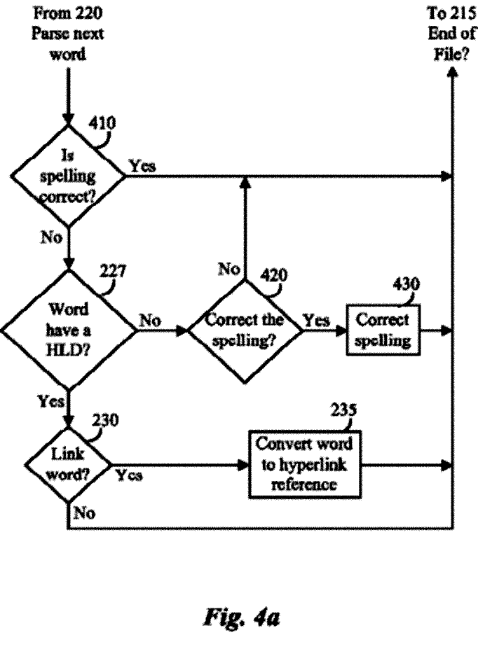

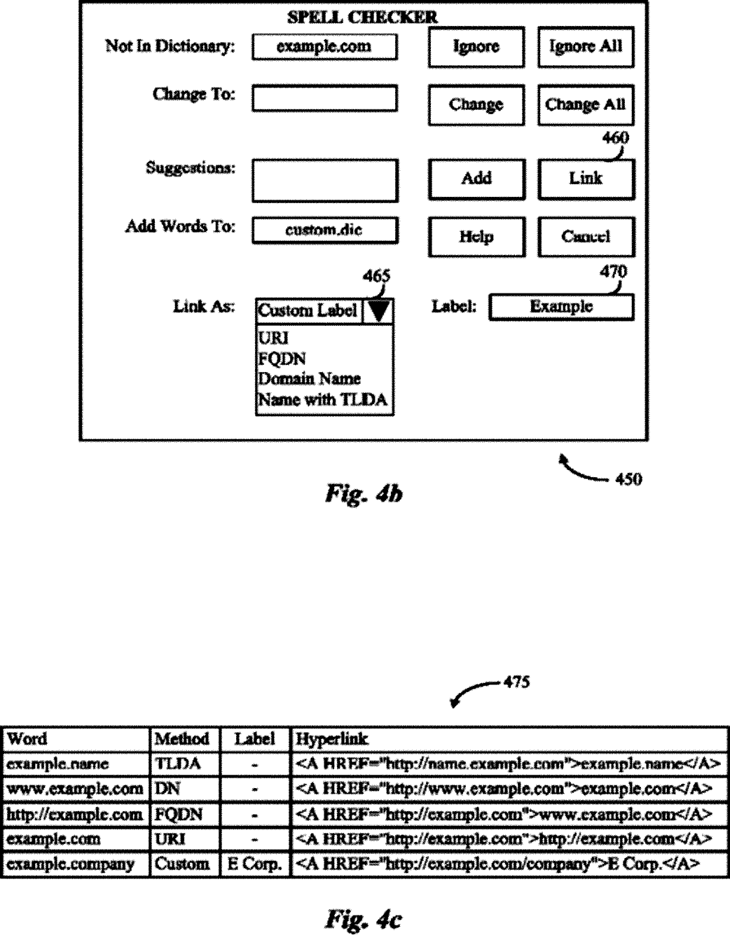

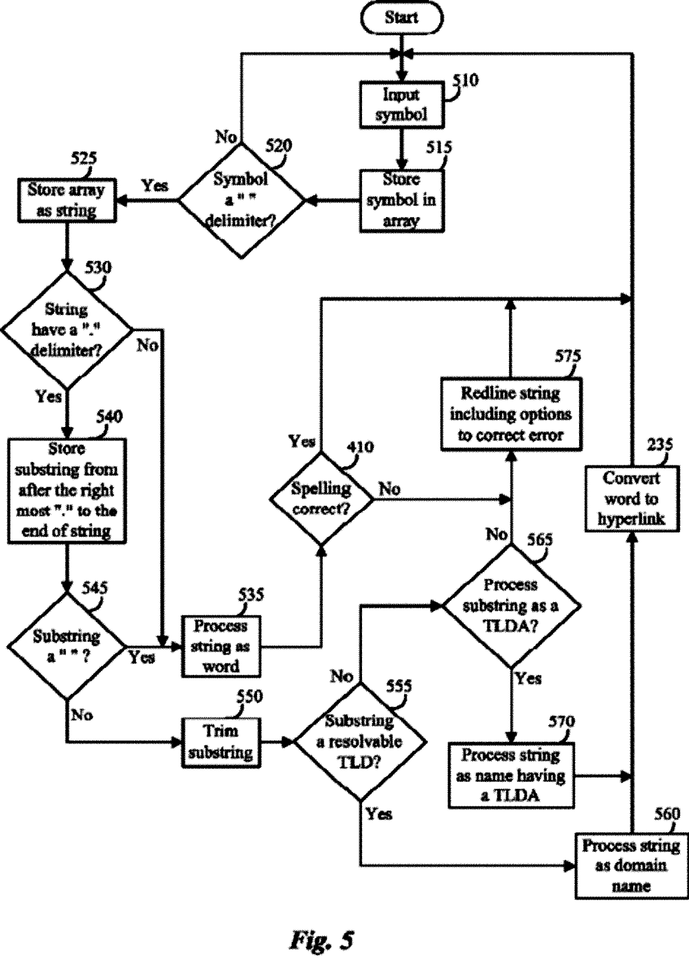

The keywords for protocol/scheme and common host server name are used to detect a URI namespace found within the namespace of written language. More specifically, the keywords may be used as criteria to detect a URI or FQDN without further regard of considering the validity or resolvability of such a detected URI or FQDN. As will be discussed in Figs. 4a, 4b, and 5, there are methods that may more effectively and reliably detect URI namespace as part of written language.

Fig. 4a illustrates how the detection of a HLD may be used to more effectively manage URI namespace. When a next word is parsed in step 220 from the current data file 310 and the spelling is not correct, then it may be further determined in step 227 whether the word includes a HLD. When it is determined that the word does not include a HLD then a user may be prompted in step 420 to correct the spelling. If this is the case, then the user may correct the spelling accordingly in step 430 with the use of a popup dictionary 184 or the like, etc. In either case, after spelling is corrected (step 430) or when it is determined that spelling is not to be corrected (step 420), then steps may be repeated (215, 220, 410) until an EOF is reached or the word includes a HLD. When it is determined (step 227) that the word includes a HLD then it may be determined in step 230 whether the word is to be linked. If the word is not converted into a hyperlink, then steps may be repeated (215, 220, 410) until an EOF is reached or the word includes a HLD. If the word is to be converted, then a hyperlink reference may be generated in step 235 from the word and then steps are repeated (215, 220, 410) until an EOF is reached or the word includes a HLD.

Fig. 4b depicts how a GUI interface 450 may be used for converting a spelling error into a hyperlink reference in one aspect of the present invention. The interface 450 is applicable to the steps illustrated in both Fig. 4a above and in Fig. 5 as will be discussed below. The interface characteristics of conventional spell checkers in use and of prior art are illustrated. Additional characteristics are illustrated such as a button object 460 for hyperlinking a spelling error, a list box object 465 for selecting what label and link method may be used to generate a hyperlink reference from the misspelled word, and a text box object 470 for providing a label name that may be used in conjunction with the selection from the list box object 465 for generating a hyperlink reference when the button object 460 for linking is activated. Furthermore, user modifiable configuration settings 174 may be used to set program preferences and the like such as having the list box 465 and text box 470 object hidden from view until the button object 460 for linking is activated.

For instance, when it is determined that a word such as "example.com" is misspelled, the link method "Custom Label" is selected, the label name is "Example", and the button object 460 for linking is activated, a hyperlink reference is generated:

<A HREF="http://www.example.com">Example</A>

The word "example.com" may then be replaced by the above hyperlink reference. The text box object 470 includes additional functionality to allow the received input of the hyperlink reference bypassing the step of automatic generation. For instance, a user may type in the hyperlink reference manually in the text box object 470.

Fig. 4c illustrates a data structure 475 for storing the received input from the GUI interface 450 of Fig. 4b. The data structure may of course be applied to other interfaces or other methods and forms of input. The misspelled word, link method, link label, and hyperlink either generated or received as input are included in the fields or columns of the illustrated data structure 475. When a URI, FQDN, or domain name is selected a label name is not required because the label name is generated as a result of specifying the link or label method. When a custom label is selected then a label name is typically entered or received as input and stored in a data table, database, or the like. Additional data structures may be appended to the data storage such as selecting a TLDA or resolution method, which is used to generate the specific permutation of a URI and/or label name. Methods for selecting TLDAs and resolution/generation/translation/response methods are explained in U.S. Patent Application Ser. No. 09/532,500 filed March 21, 2000, by Schneider, entitled "Fictitious domain name method, product, and apparatus."

Fig. 5 illustrates a preferred aspect of the present invention by showing steps for spell checking as symbols/characters are entered, processed, or received one symbol or one character at a time. This illustration pertains only to the steps of how a word is determined, differentiated, and processed. These steps are repeatable for each word as each symbol is entered. Because the " " delimiter is a common delimiter across a multitude of namespaces, the illustrated steps use the " " delimiter to differentiate an "atomic" word from an array of symbols. Of course, variations such as detecting a "." delimiter first, as an improvement for preprocessing potential outcomes before detecting a " " delimiter (e.g., detecting a "." delimiter followed by any symbol that is not a " " delimiter), or any other such variation or modification too numerous to list may be practiced in accordance with methods known to one of ordinary skill in the art.

A dynamic link library (DLL), applet, servlet, or the like may be accessed from memory 168 to provide real-time spelling corrections or hyperlink conversions when the presence of a delimiter is determined. As each symbol is entered, processed, or received as input in step 510, the symbol is stored in an array of symbols in step 515 until a " " delimiter is detected in step 520. When the " " is detected, the array is stored as a string in step 525. If it is determined in step 530 that the string does not include a "." delimiter, then the string may be processed in step 535 as a word. However, when it is determined that the string includes a "." delimiter, then a substring may be stored in step 540 from after the right most "." delimiter to the end of string. If it is determined that the substring is a " " delimiter then (e.g., detects that the "." is the period punctuation mark) the string may then be processed as a word in step 535. However, when it is determined in step 545 that the substring is other than a " ", the substring may then be trimmed in step 550 of white spaces (removes any surrounding " " delimiters) and then may further be determined in step 555 whether the substring is a resolvable TLD (".com", ".net", etc.).

If the substring is a resolvable TLD, then the string may be processed in step 560 as a domain name, FQDN, or URI. If the substring is not a resolvable TLD, then it may be determined in step 565 whether the substring is processed as a TLDA. If so, then the string may be processed in step 570 as a FDN or name having a TLDA. When it is determined in step 565 that the substring is not processed as a TLDA, the string may be redlined in step 575 indicating that there is a spelling or grammatical error with options or suggestions to correct the error. When the string is processed as either a TLD or TLDA, the word or string may then be automatically converted in step 235 into a hyperlink reference. When the string is processed as a word it may then be determined in step 410 whether the spelling is correct.

When the spelling is not correct, the string may be redlined in step 575 indicating that there is a spelling or grammatical error with options or suggestions to correct the error. Whenever the spelling is (step 410) correct, or the word is redlined (step 575), or converted (step 235) into a hyperlink reference; a DLL, applet, servlet, executable program, script, etc. may be employed to process corrections, deletions, modifications, etc., or process the next consecutive symbol that is entered, processed, or received as input. Furthermore, the link may be marked up with a distinguishable indicator. For instance the link may be displayed using distinguishable features such as fonts, character size, color, underlining, background attributes, reverse video, etc. As will be readily apparent to those skilled in the art, other distinguishing characteristics may be used without departing from the spirit and scope of the invention.

The generalized methods discussed above apply to any text file or document including web pages that use tagging systems such as but not limited to HTML, DHTML, XML, XHTML, and SGML, etc., e-mail, newsgroup, or any file that represents information that may be applicable for applying hyperlinks. Any standalone application including a program, servlet, or applet, etc. or any function, macro, or script including VB Script, JavaScript, or PERL script, etc. is called or executed by a text processing device to process text on-the-fly or in a batch. For instance, steps may be performed to generate a new file or files, or modify an input file or files, from a given input file or batch of input files. In addition, aspects of the present invention may extend the use of spell checking when applied to streaming text or real time decoded text such as but not limited to teletext, closed caption, analog and/or digital audio and/or video signals, broadcasts, instant messaging, chat rooms, web conferencing, telephone, etc.

Although the invention has been shown and described with respect to a certain preferred aspect or aspects, it is obvious that equivalent alterations and modifications will occur to others skilled in the art upon the reading and understanding of this specification and the annexed drawings. In particular regard to the various functions performed by the above described items referred to by numerals (components, assemblies, devices, compositions, etc.), the terms (including a reference to a "means") used to describe such items are intended to correspond, unless otherwise indicated, to any item which performs the specified function of the described item (e.g., that is functionally equivalent), even though not structurally equivalent to the disclosed structure which performs the function in the herein illustrated exemplary aspect or aspects of the invention. In addition, while a particular feature of the invention may have been described above with respect to only one of several illustrated aspects, such feature may be combined with one or more other features of the other aspects, as may be desired and advantageous for any given or particular application.

The description herein with reference to the figures will be understood to describe the present invention in sufficient detail to enable one skilled in the art to utilize the present invention in a variety of applications and devices. It will be readily apparent that various changes and modifications could be made therein without departing from the spirit and scope of the invention as defined in the following claims.

1. A word processing method for processing text including one or more words comprising: starting a spell check type program for evaluating said one or more words; determining that a word of said one or more words includes an error, said word including at least one of a spelling error, grammatical error, and punctuation error; determining whether said word including said error is one of a uniform resource locator (URL) and fully qualified domain name (FQDN); and, said spell check type program automatically displaying an enhanced spell check type user interface, said user interface providing a user an ability to correct said word including said at least one of a spelling error, grammatical error, and punctuation error and said user interface further providing said user an ability to construct a hyperlink including said error in response to said determining that said word including said error is neither said URL nor said FQDN wherein said hyperlink includes a label and a hyperlink reference, said label including said error and said hyperlink reference capable of accessing a network resource corresponding to at least one of a word and error.

2. The method, as set forth in claim 1, wherein said determining that said word includes said error includes determining that said word starts and ends with a word delimiter.

3. The method, as set forth in claim 2, wherein said determining that said word starts and ends with said word delimiter includes receiving an input character and determining that said input character is said word delimiter.

4. The method, as set forth in claim 2, wherein said word delimiter is represented by a spacebar symbol.

5. The method, as set forth in claim 2, further including determining that said word includes at least one punctuation period symbol wherein said at least one punctuation period symbol is positioned between said start and end of said word.

6. The method, as set forth in claim 5, further including determining that said word including said at least one of a punctuation period symbol includes a fictitious domain name (FDN) including a top level domain alias and said user interface further providing said user an ability to construct said label from said FDN and construct said hyperlink reference including a resolvable domain name corresponding to said network resource, said resolvable domain name including at least a portion of said FDN.

7. The method, as set forth in claim 1, wherein said enhanced spell check type user interface includes at least one user interface element configured to allow said user to construct said hyperlink by choosing from at least one of a hyperlink reference method operation, and hyperlink label method operation.

8. The method, as set forth in claim 1, wherein said enhanced spell check type user interface includes user modifiable configuration settings.

9. A word processing method comprising: inputting a symbol and determining that said symbol is a word delimiter positioned at an end of a word, said word including one or more symbols; accessing a spell check type program for evaluating said word; determining that said word includes an error, said word including at least one of a spelling error, grammatical error, and punctuation error; determining whether said word including said error is one of a uniform resource locator (URL) and fully qualified domain name (FQDN); and, said spell check type program automatically displaying an enhanced spell check type user interface, said user interface providing a user an ability to correct said word including said at least one of a spelling error, grammatical error, and punctuation error and said user interface further providing said user an ability to construct a hyperlink including said error in response to said determining that said word including said error is neither said URL nor said FQDN wherein said hyperlink includes a label and a hyperlink reference, said label including said error and said hyperlink reference capable of accessing a network resource corresponding to at least one of a word and error.

10. The method, as set forth in claim 9, wherein said determining that said word includes said error includes determining that said word starts and ends with a word delimiter.

11. The method, as set forth in claim 10, wherein said word delimiter is represented by a spacebar symbol.

12. The method, as set forth in claim 10, further including determining that said word includes at least one punctuation period symbol wherein said at least one punctuation period symbol is positioned between said start and end of said word.

13. The method, as set forth in claim 12, further including determining that said word including said at least one of a punctuation period symbol includes a fictitious domain name (FDN) including a top level domain alias and said user interface further providing said user an ability to construct said label from said FDN and construct said hyperlink reference including a resolvable domain name corresponding to said network resource, said resolvable domain name including at least a portion of said FDN.

14. The method, as set forth in claim 9, wherein said enhanced spell check type user interface includes at least one user interface element configured to allow said user to construct said hyperlink by choosing from at least one of a hyperlink reference method operation, and hyperlink label method operation.

15. The method, as set forth in claim 9, wherein said enhanced spell check type user interface includes user modifiable configuration settings.

16. A word processing method comprising: selecting a word to convert into a hyperlink, said hyperlink including a hyperlink reference and a hyperlink label wherein said word includes one of a uniform resource locator (URL), fully qualified domain name (FQDN), domain name, fictitious domain name (FDN), and multilingual domain name (MDN); displaying a hyperlink tool including a user interface, said user interface including at least one user interface element configured to allow a user to generate a hyperlink label from said word; choosing a hyperlink label type from said user interface element, said hyperlink label type selected from a group including a uniform resource locator (URL) label type, fully qualified domain name (FQDN) label type, fictitious domain name (FDN) label type, multilingual domain name (MDN) label type, domain name label type, and custom label type wherein each said hyperlink label type corresponds to a hyperlink label method; automatically generating said hyperlink label and said hyperlink reference from said hyperlink label method corresponding to said selected hyperlink label type; and, converting said word into said hyperlink including said generated hyperlink reference and said generated hyperlink label.

17. The method, as set forth in claim 16, wherein said word includes one of a FDN and MDN further including said hyperlink label method accessing one of a FDN and MDN resolution method for converting said FDN into said hyperlink reference.

18. The method, as set forth in claim 17, wherein said accessing said one of a FDN and MDN resolution method is accessed from one of a table and FDN/MDN registry.

19. The method, as set forth in claim 17, wherein said hyperlink reference includes a resolvable domain name and at least a portion of said one of a FDN and MDN.

20. The method, as set forth in claim 16, further including a spell check type program selecting said word to convert into said hyperlink.
